(19) United States
(12) Patent Application Publication
(10) Pub. No.: US 2016/0202208 A1
(43) Pub. Date: Jul. 14, 2016

(54) MULTIPLEXING DETECTION SYSTEM OF DUAL GATE ION-SENSITIVE FIELD-EFFECT TRANSISTOR SENSOR

(71) Applicant: KOREA INSTITUTE OF SCIENCE AND TECHNOLOGY, Seoul (KR)

(72) Inventors: Kwan Hyi LEE, Seoul (KR); Seok LEE, Seoul (KR); Minhong JEUN, Seoul (KR); Inkyu LEE, Seoul (KR); Jung Hoon PARK, Seoul (KR); Won-Ju CHO, Namyangju-si (KR); Hyun-June JANG, Seoul (KR)

(73) Assignee: KOREA INSTITUTE OF SCIENCE AND TECHNOLOGY, Seoul (KR)

(21) Appl. No.: 14/925,172

(22) Filed: Oct. 28, 2015

(30) Foreign Application Priority Data
Jan. 14, 2015 (KR) 10-2015-0007017

(51) Int. Cl. G01N 27/414

(52) U.S. Cl. CPC G01N 27/4145

(57) ABSTRACT

A multiplexing detection system of a dual gate ion-sensitive field effect transistor bio sensor of the present invention includes: a first dual gate ion-sensitive field effect transistor bio sensor; and a second dual gate ion-sensitive field effect transistor bio sensor, wherein a first bio signal is sensed through the first dual gate ion-sensitive field effect transistor bio sensor, and a second bio signal is sensed through the second dual gate ion-sensitive field effect transistor bio sensor, and the first bio signal and the second bio signal are different in type from each other.

### CROSS-REFERENCE TO RELATED APPLICATION

This application claims priority to and the benefit of Korean Patent Application No. 1 0-201 5-000701 7 filed in the Korean Intellectual Property Office on Jan. 14, 2015, the entire contents of which are incorporated herein by reference.

### BACKGROUND

(a) Field

The present invention provides a multiplexing detection system of a dual gate ion-sensitive field-effect transistor bio sensor.

(b) Description of Related Art

A future point of care (POC) system provides a diagnosis system that can immediately diagnose a disease. Such a system can provide an early diagnosis and a prognosis observation of disease, and can prevent rage of a contagious disease. The POC system requires low cost, speed, high-sensitivity, and multiplexing signal detection ability with respect to various biomarkers. Among various diagnosis platforms, a bio sensor using a transistor is a converter that can acquire an electric signal from the biomarker. The bio sensor using a transistor may transistor has been gaining attention as a platform of the next generation POC diagnosis system because it can down-size an optic-based diagnosis system that requires large-scaled analysis equipment and lab analysis (N. J. Jang et al., Electrical Signaling of Enzyme-Linked Immunosorbent Assays with an Ion-Sensitive Field-Effect Transistor, Biosens. Bioelectron, 64, pp 318-323, 2015).

The bio sensor using a transistor is hyper sensitive, and can promptly diagnose a disease. In addition, since the bio sensor can integrate a plurality of unit sensors, the bio sensor can be utilized as a platform that can perform multiplexing detection with respect to the biomarker (Zheng, G. F. et al., Multiplexed electrical detection of cancer markers with nanowire sensor arrays. Nat. Biotechno. 23, pp 1294-1301, 2005).

The biomarker implies a single molecule or molecules that include various metabolism materials including protein, DNA derived nucleic acid, RNA derived nucleic acid, and the like. The biomarker is revealed when a specific disease occurs and served as a direct index of the disease. The amount of revelation and type of the biomarker are changed not only according to of particularity of the disease but also according to a degree of progress of the disease. Accordingly, when a specific disease is diagnosed, a plurality of biomarkers-based diagnosis system is required because there is high possibility of misdiagnosis when the disease is diagnosed through a single biomarker.

Conventionally, a biomarker is quantified to an attomolar level by utilizing a nano material-based technology such as carbon nanotube, nanowire, graphene, and the like. A one-dimensional or two-dimensional structure of the nano material eases collection of bio signals because it provides a wide surface area to a bio material. However, one-dimensional or two-dimensional structure of the nano material cannot be commercially available due to complexity in process and insufficient yield.

An ion-sensitive field effect transistor (hereinafter, referred to as an ISFET) having a planar structure is a platform that has already been commercialized as a handheld pH sensor.

Conventionally, there has been an attempt to implement a bio material as an enzyme sensor, an antigen-antibody sensor, a DNA sensor, and the like by functionalizing the same to a gate oxide layer of the ISFET. Further, in order to extend the use of ISFET sensor to a bio sensor, a method for separating a common field effect transistor and a sensing portion by adopting an extended-gate field-effect transistor that can be easily commercialized has been reported (C. Li-Lun et al., Study on extended gate field effect transistor with tin oxide sensing membrane, Materials Chemistry and Physics 63, pp 19-23, 2000). The suggested SnO₂ sensing portion is completely separated from a common transistor. Accordingly, when being used in a bio sensor, deterioration of the SnO₂ sensing portion, which may occur due to a chemical element such as potassium and sodium can be prevented. Further, since cost of the SnO₂ sensing portion is low, it can be easily replaced such that possibility of commercialization of an ISFET-based bio sensor can be improved. However, the proposed SnO₂ sensing portion has limited sensitivity of maximum of about 59 mV/Ph at a room temperature due to Nernst reaction. Thus, the proposed SnO₂ cannot be implemented as an antigen-antibody sensor due to low sensitivity of debye length.

In 2010, Mark-Jan Spijkman developed a dual-gate structured ISFET having an improved pH sensitivity by adding a lower electrode to an existing ISFET (Mark-Jan Spijkman et al., Dual-Gate Organic Field-Effect Transistors as Potentiometric Sensors in Aqueous Solution, Adv. Funct. Mater., 20, pp 898-905, 2010). This has been suggested as a sensor platform that can overcome a limit due to Nernst reaction by using capacitive coupling that occurs in upper and lower electrodes. However, the capacitive coupling causes a current leakage, and a transistor may be damaged due to various ions because the sensing portion and a thin film transistor are not separated.

The above information disclosed in this Background section is only for enhancement of understanding of the background of the invention and therefore it may contain information that does not form the prior art that is already known in this country to a person of ordinary skill in the art.

### SUMMARY

An exemplary embodiment of the present invention has been made in an effort to provide a multiplexing detection system having advantages of low cost and fast, simple, and precise diagnosis while having sensitivity that exceeds a Nernst reaction limit.

An exemplary embodiment of the present invention provides a multiplexing detection system that can simultaneously detect signals with respect to a plurality of biomarkers to an attomole level.

The present invention may be used to obtain other technical objects that are not mentioned in detail.

A multiplexing detection system of a dual gate ion-sensitive field effect transistor bio sensor according to an exemplary embodiment of the present invention includes: a first dual gate ion-sensitive field effect transistor bio sensor; and a second dual gate ion-sensitive field effect transistor bio sensor, wherein a first bio signal is sensed through the first dual gate ion-sensitive field effect transistor bio sensor, and a second bio signal is sensed through the second dual gate ion-sensitive field effect transistor bio sensor, and the first bio signal and the second bio signal are different in type from each other.

The dual gate ion-sensitive field effect transistor bio sensor may include a dual gate ion-sensitive field effect transistor, and the dual gate ion-sensitive field effect transistor may include: a lower gate electrode; a lower insulating layer provided on the lower gate electrode; a source and a drain provided on the lower insulating layer and separated from each other; a channel layer provided on the lower insulating layer and disposed between the source and the drain; an upper insulating layer provided on the source, the drain, and the channel layer; and an upper gate electrode provided on the upper insulating layer.

Further, the thickness of an equivalent oxide layer of the upper insulating layer may be smaller than that of an equivalent oxide layer of the lower insulating layer.

The channel layer may have a thickness of 10 nm or less.

The dual gate ion-sensitive field effect transistor bio sensor may include a replaceable sensor connected with the dual gate ion-sensitive field effect transistor bio sensor, and the replaceable sensor may include a metal electrode connected with the upper gate electrode and a sense layer provided on the metal electrode and sensing ion.

A source of the first dual gate ion-sensitive field effect transistor bio sensor and a source of the second dual gate ion-sensitive field effect transistor bio sensor may be commonly grounded, and an upper gate electrode of the first dual gate ion-sensitive field effect transistor bio sensor and an upper gate of the second dual gate ion-sensitive field effect transistor bio sensor may be commonly grounded.

In addition, a common voltage may be applied to a lower gate electrode of the first dual gate ion-sensitive field effect transistor bio sensor and a lower gate electrode of the second dual gate ion-sensitive field effect transistor bio sensor may be commonly grounded.

A drain of the first dual gate ion-sensitive field effect transistor bio sensor may output the first bio signal, and a drain of the second dual gate ion-sensitive field effect transistor bio sensor may output the second bio signal.

The drain of the first dual gate ion-sensitive field effect transistor bio sensor and the drain of the second dual gate ion-sensitive field effect transistor bio sensor may be connected in a parallel structure.

The replaceable sensor may include a receptor where at least one of an antibody, a cell, and a DNA is functionalized, and the replaceable sensor and the receptor may be electrically connected.

The exemplary embodiment of the present invention can provide a multiplexing detection system having advantageous of low cost and prompt, simple, and precise diagnosis while simultaneously sensing signals with respect to a plurality of biomarkers and having sensitivity that exceeds a Nernst reaction limit.

### BRIEF DESCRIPTION OF THE DRAWINGS

FIG. 1 is a cross-sectional view of a dual gate ion-sensitive field-effect transistor bio sensor combined with a sensor according to an exemplary embodiment of the present invention.

FIG. 2 is a schematic view of a connection between the dual gate ion-sensitive field-effect transistor bio sensor and the sensor according to the exemplary embodiment of the present invention.

FIG. 3 is a schematic view of a multiplexing detection system of two dual gate ion-sensitive field effect transistor bio sensors according to an exemplary embodiment of the present invention.

FIG. 4 is a graph illustrating pH detection characteristic of FIG. 3.

FIG. 5 is a schematic view of a multiplexing detection system of three dual gate ion-sensitive field effect transistor bio sensors according to an exemplary embodiment of the present invention.

FIG. 6A is a graph illustrating a result of detecting CEACAM-1 biomarker using FIG. 5.

FIG. 6B is a graph illustrating a result of detecting GDF-1 biomarker using FIG. 5.

FIG. 6C is a graph illustrating a result of detecting PAUF biomarker using FIG. 5.

### DETAILED DESCRIPTION

Hereinafter, exemplary embodiments of the present invention will be described in detail with reference to the attached drawings such that the present invention can be easily put into practice by those skilled in the art. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification. In addition, the detailed description of the widely known technologies will be omitted.

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. When an element is referred to as being “directly on” another element, there are no intervening elements present. Similarly, it will be understood that when an element such as a layer, film, region, or substrate is referred to as being “under” another element, it can be “directly under” the other element or intervening elements may also be present. In contrast, when an element is referred to as being “directly on” another element, there are no intervening elements present.

In addition, unless explicitly described to the contrary, the word “comprise” and variations such as “comprises” or “comprising”, will be understood to imply the inclusion of stated elements but not the exclusion of any other elements.

In the specification, the term, “bio signal” implies conversion of an electric signal acquired from disease of infection biomarkers.

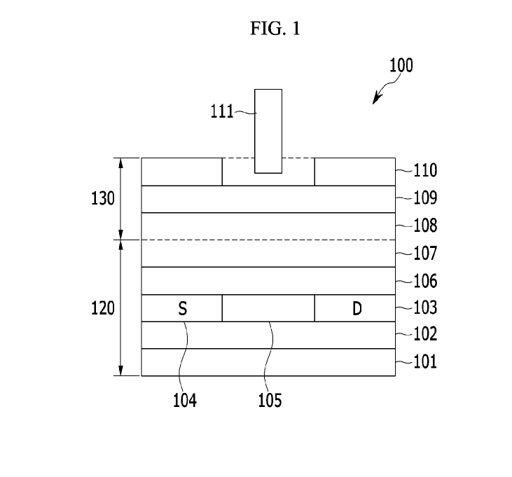

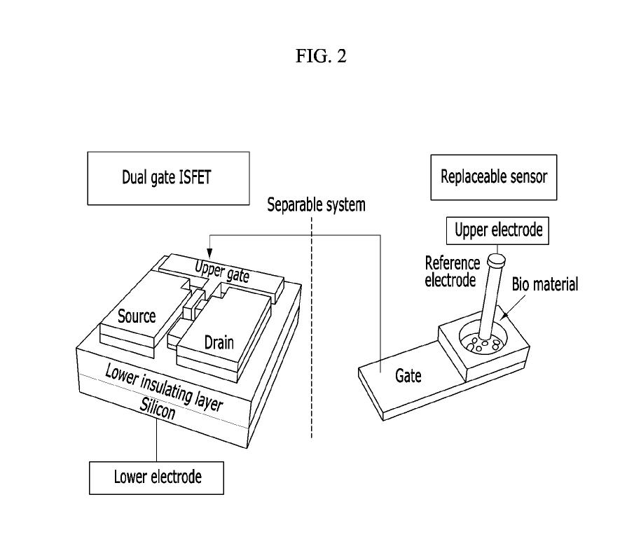

FIG. 1 is a cross-sectional view of a dual gate ion-sensitive field effect transistor (ISFET) bio sensor combined with a sensor according to an exemplary embodiment of the present invention, and FIG. 2 is a schematic diagram simply illustrating connection between the dual gate ISFET and the sensor according to the exemplary embodiment of the present invention.

In FIG. 1, a dual gate ion-sensitive field effect transistor bio sensor 100 combined with the sensor includes a dual gate ion-sensitive field effect transistor (ISFET) bio sensor 100 and a replaceable sensor 130. In this case, the dual gate ISFET 120 and the replaceable sensor 130 are electrically connected with each other as shown in FIG. 2.

The dual gate ISFET 120 may include a lower gate electrode 101, a lower insulating layer 102 disposed on the lower gate electrode 101, a channel layer 150 provided on the lower insulating layer 102 and disposed between a source 104 and a drain 103, the source 104, the drain 103, an upper insulating layer 106 provided on the channel layer 105, and an upper gate electrode 17 provided on the upper insulating layer 106.

The replaceable sensor 130 includes a metal electrode 108 connected with the upper gate electrode 107, a sensing layer 109 disposed on the metal electrode 108 and sensing ion, and a chamber 101 provided on the sensing layer 109.

Hereinafter, parts that are generally well known among constituent elements of the dual gate ISFET 120 and the replaceable sensor 130 according to the exemplary embodiment of the present invention will not be further described.

A small surface potential voltage difference occurred in the replaceable sensor 130 significantly amplifies a threshold voltage variation of a lower field effect transistor due to super capacitive coupling generated in the dual gate ISFET 120 including a hyper thin film channel layer having a thickness of 10 nm or less.

As the bio signal is amplified due to electric combination of the dual gate ISFET 120 such that a signal with respect to the biomarker can be quantified to an attomole level. Thus, the diagnosis system can simply diagnose by directly using a clinical sample without using a PBS buffer solution.

An equivalent oxide thickness of the upper insulating layer 106 may be thinner than that of the lower insulating layer 102. For example, the thickness of the upper insulating layer 106 may be about 25 nm or less, and the thickness of the lower insulating layer 102 may be about 100 nm or more. When the equivalent oxide thickness of the upper insulating layer 106 is less than that of the lower insulating layer 102, sensitivity amplification of about 59 mV/pH or more can be triggered by using capacitive coupling.

That is, capacitive coupling can be utilized by using the upper and lower gate electrodes 101 and 107 in the dual gate structure without limiting the width or length of the channel layer 105.

### Exemplary Embodiment 1: Dual Gate ISFET Array

A substrate is made of a silicon or insulator (SOI) having resistivity of about 10 to 20 Ωcm, and the thickness of a silicon, which is a lower gate electrode 101, is about 107 nm, and the thickness of an SiO₂ oxide layer, which is a lower insulating layer 102 is about 700 nm.

Standard RAC cleansing is performed to the lower insulating layer 102, an ultra-thin film is formed by etching the upper silicon with about 2.38 w % of a tertramethylammonium hydroxide (TMAH) solution, and a channel area 105 is formed using photolithography. In this case, the length, the width, and the thickness of the channel 105 are respectively about 20 μm, about 20 μm, and about 4.3 nm.

Next, an n-type polysilicon is deposited on the lower insulating layer 102 using chemical vapor deposition (CVD) equipment and the source 104 and the drain 103 are formed.

Next, an upper insulating layer 106 is formed by oxidizing silicon dioxide having a thickness of about 5 nm on the source 104 and the drain 103.

Next, an Al thin layer having a thickness of about 150 nm is deposited on the upper insulating layer 106 using an E-beam evaporator such that an upper gate electrode 107 is formed. In this case, a source common ground contact of the two transistors 120 and 130 is also formed.

Next, a dual gate ISFET array 120 is heat-treated at a temperature of about 450° C. in a gas atmosphere including N₂ and H₂ such that a defect of the dual gate ISFET array 120 is removed and an interface state can be improved.

### Exemplary Embodiment 2: Replaceable Sensor

As a substrate, a p-type (100) orientation silicon where SiO₂ is grown and having a thickness of about 300 nm is used.

Standard RAC cleansing is performed to the substrate, and indium tin oxide (ITRO) is deposited with a thickness of about 100 nm using an E-beam evaporator. In this case, ITO is served as a metal electrode 108 transmitting electric potential change in the surface of the replaceable sensor 130.

Next, a SnO₂ layer, which is a sense layer 109, is deposited with a thickness of about 45 nm on an ITO layer 108 using an RF sputter. In this case, RF power is about 50 W.

Next, a sputtering process is performed under an Ar gas atmosphere having a flow rate of about 20 sccm and a pressure of about 3 mtorr.

Next, for injection of a pH solution, a chamber 110 is made of polydimethylsiloxane (PDMS) and then attached on the sense layer 109 such that a replaceable sensor 130 is manufactured.

### Exemplary Embodiment 3: Multiplexing Detection System of Two Dual Gate ISFET Bio Sensors

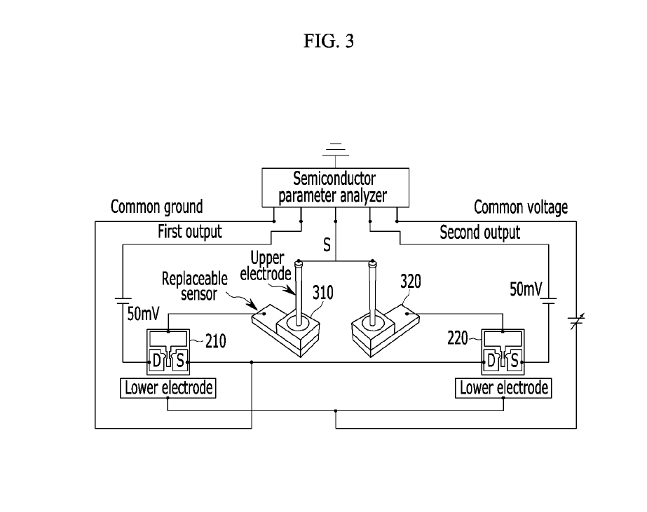

FIG. 3 is a schematic view simply illustrating a multiplexing detection system of two dual gate ion detection field effect transistor bio sensors according to the exemplary embodiment of the present invention.

Specifically, FIG. 3 shows a unit circuit detecting different types of bio signals from different types of biomarkers using two dual gate ISFET sensors.

The replaceable sensor of FIG. 3 is combined to the upper gate electrode of the dual gate ISFET through electric contact in a separable and combinable form. For example, the replaceable sensor may be combined to the dual gate ISFET as a plug type.

A receptor (not shown in FIG. 3) is combined to the replaceable sensor, and at least one of antibody, cell, and DNA is functionalized.

In FIG. 3, a source of the first dual gate ISFET 210 and a source the second dual gate ISFET 220 are commonly grounded, and an upper electrode of the first replaceable sensor 310 and an upper electrode of the second replaceable sensor 320 are commonly grounded (here, the upper electrodes are Ag/AgCl reference electrodes).

A constant common voltage is applied to a lower electrode of first dual gate ISFET 210 and a lower electrode of the second dual gate ISFET 220.

A drain of the first dual gate ISFET 210 and a drain of the second dual gate ISFET 220 are in parallel with each other, and detects different bio signals respectively and transmits the sensed bio signals through a semiconductor parameter analyzer.

### EXPERIMENTAL EXAMPLE 1

### pH Characteristic Evaluation

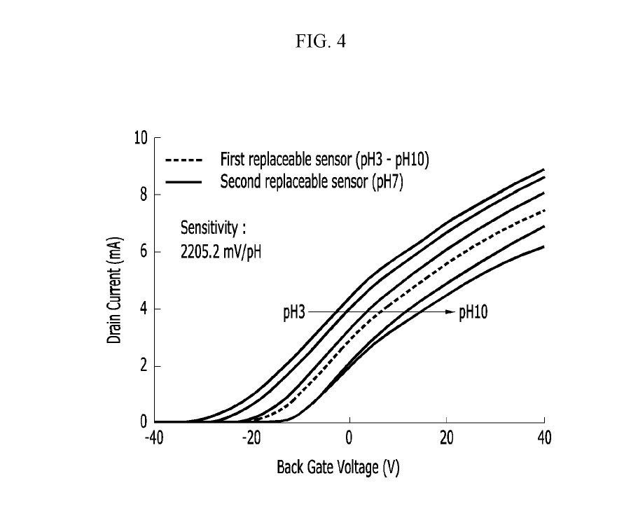

FIG. 4 is a graph illustrating pH detection characteristic of FIG. 3.

In Experimental Example 1, solutions of pH3 to pH10 were sequentially injected to a sense layer of a first replaceable sensor 310, and a pH7 solution was iteratively injected to a sense layer of the second replaceable sensor 320.

As a result of the experiment, a transmission characteristic of the first dual gate ISFET 210 connected with the first replaceable sensor 310 where PH of injected solution is changed is constantly changed according to pH. Further, a small surface potential voltage difference occurred from the replaceable sensor causes significant amplification of a threshold voltage variation of a lower field effect transistor due to super capacitive coupling such that sensitivity of about 2.2 V/pH was acquired. This is high sensitivity that exceeds about 40 times Nernst reaction limit. On the other hand, no change occurred in a transmission characteristic of the second dual gate ISFET 220 connected with the second replaceable sensor 320 where pH of the injected solution is not changed.

That is, it can be observed through Experimental Example 1 that even through two dual gate ISFET sensors independently operate, they simultaneously acquire sense signals.

### Exemplary Embodiment 4: Receptor-Attached Replaceable Sensor

An OH group is formed using O₂ in the surface of an initial sense layer so as to fix various antibodies that respond to pancreatic cancer to the surface of the sense layer of the replaceable sensor manufactured from exemplary embodiment 2.

Next, the surface of the sense layer is reacted with about 5% of (3-aminopropyl)trimethoxysilane diluted with ethanol for about 1 hour such that an amino group is formed in the surface of the sense layer.

Next, about 1 M of succinic anhydride is injected and then reacted at about 37° C. for about 4 hours such that a carboxylic group is formed in the surface of the sense layer.

Next, the surface of the sense layer is reacted with about 0.4M of N-hydroxysuccinimide and about 0.1M of ethyl(dimethylaminopropyl)carbodiimide) for about 15 monites. Then, CEACEM-1, GDF-1, PAUF antibodies are fixed to the sense layers of the respective replaceable sensors.

### Exemplary Embodiment 5: Multiplexing Detection System of Three Dual Gate ISFET Bio Sensors

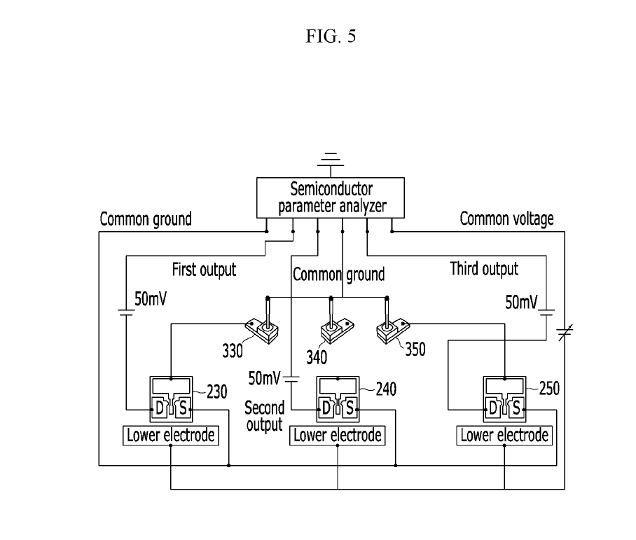

FIG. 5 is a schematic view simply illustrating a multiplexing detection system of three dual gate ISFET bio sensors according to an exemplary embodiment of the present invention.

Specifically, FIG. 5 illustrates a unit circuit that senses three types of bio signals using three dual gate ISFET sensors.

In FIG. 5, a source of a third dual gate ISFET 230, a source of a fourth dual gate ISFET 240, and a source of a fifth dual gate ISFET 250 are respectively commonly grounded with an upper electrode of a third replaceable sensor 330, an upper electrode of a fourth replaceable sensor 340, and an upper electrode of a fifth replaceable sensor 350

Lower electrodes of the third dual gate ISFET 230, the fourth dual gate ISFET 240, and the fifth dual gate ISFET 250 are applied with a constant common voltage.

A drain of the third dual gate ISFET 230, a drain of the fourth dual gate ISFET 240, and a drain of the fifth dual gate ISFET 250 are parallel with each other, and sense different bio signals and output the sensed bio signals through a semiconductor parameter analyzer.

### EXPERIMENTAL EXAMPLE 2

### Pancreatic Cancer Biomarker Sensitivity Characteristic Evaluation

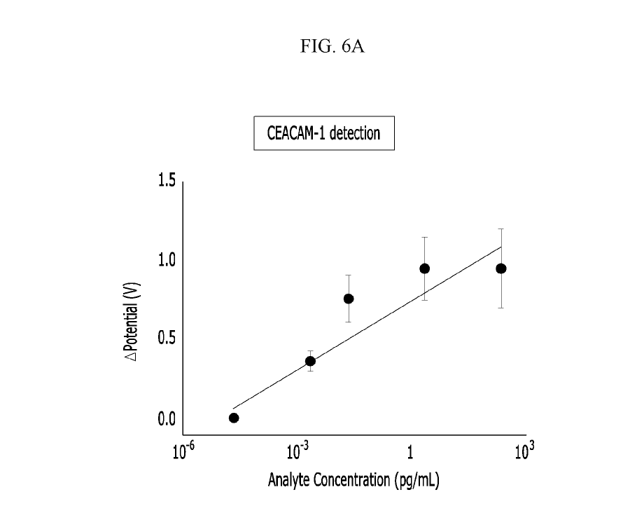

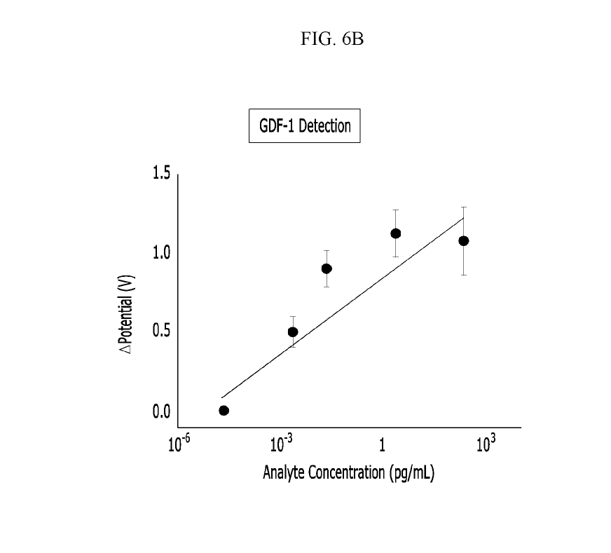

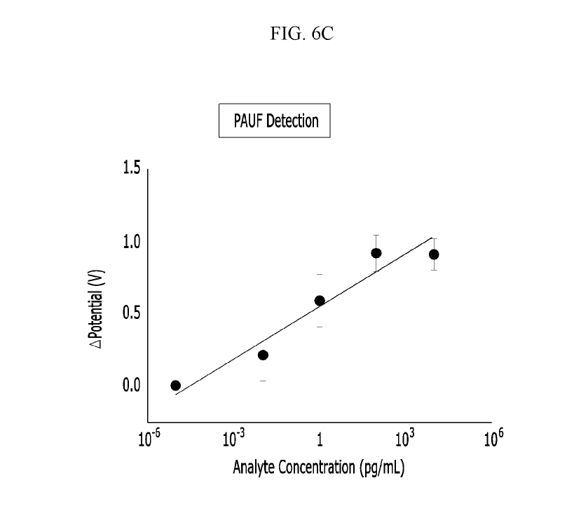

FIG. 6A is a graph illustrating a result of detecting CEACAM-1 biomarker using FIG. 5, FIG. 6B is a graph illustrating a result of detecting GDF-1 biomarker using FIG. 5, and FIG. 6C is a graph illustrating a result of detecting PAUF biomarker using FIG. 5

Experimental Example 2 shows a result of simultaneous measurement of signals with respect to three pancreatic cancer biomarkers. In this case, CEACEM-1, GDF-1, and PAUF antibodies are respectively fixed to sense layers of third, fourth, and fifth replaceable sensors 330, 340, and 350, and CEACEM-1, GDF-1, PAUF biomarkers are injected to a serum of human body and reaction per concentration was sensed.

As a result of the experiment, as shown in FIG. 6A, FIG. 6B, and FIG. 6C, three dual gate ISFETs respectively operate to sense signals with respect to the biomarkers, and the signals were simultaneously sensed.

The sensor-combined dual gate ISFET sensor according to the exemplary embodiment of the present invention uses a dual gate ISFET having high process cost in detection of biomarkers, and the replaceable sensor that can be separated from and combined with the dual gate ISFET can be replaceable.

The sensor-combined dual gate ISFET sensor according to the exemplary embodiment of the present invention can improve sensitivity characteristic compared to a conventional ISFET-based antigen-antibody sensor, and is capable of multiple detection. Further, the sensor-combined dual gate ISFET sensor can be used as at least one of a cell-based sensor, an antigen-antibody sensor, or a DNA sensor.

The multiple detection system of the dual gate ion-sensitive field effect transistor bio sensor according to the exemplary embodiment of the present invention can diagnose at least one of hepatitis B, avian influenza, hand-foot-and-mouth disease, pancreatic cancer, prostate cancer, cervical cancer, and liver cancer.

Although exemplary embodiment 1 to exemplary embodiment 5 according to the exemplary embodiment of the present invention have been disclosed, the exemplary embodiment 1 to the exemplary embodiment 5 are examples for detailed description of the present invention, and the present invention is not limited thereto.

Although the exemplary embodiment of the present invention has been described in detail hereinabove, the scope of the present invention is not limited thereto. That is, several modifications and alterations made by those skilled in the art using a basic concept of the present invention as defined in the claims fall within the scope of the present invention.

<Description of symbols>

| | |
|---|---|
| 100: | sensor-combined dual gate ion-sensitive electric |
| | field effect transistor bio sensor |
| 101: | lower gate electrode |
| 102: | lower insulating layer |
| 103: | drain |
| 104: | source |
| 105: | channel layer |
| 106: | upper insulating layer |
| 107: | upper gate electrode |
| 108: | metal electrode |
| 109: | sense layer |
| 110: | chamber |
| 111: | reference electrode, upper electrode |
| 120: | dual gate ion-sensitive field effect transistor (ISFET) |
| 130: | replaceable sensor |

What is claimed is:

1. A multiplexing detection system comprising:
a first dual gate ion-sensitive field effect transistor bio sensor; and
a second dual gate ion-sensitive field effect transistor bio sensor,
wherein a first bio signal is sensed through the first dual gate ion-sensitive field effect transistor bio sensor, and a second bio signal is sensed through the second dual gate ion-sensitive field effect transistor bio sensor, and
the first bio signal and the second bio signal are different in type from each other.

2. The multiplexing detection system of the dual gate ion-sensitive field effect transistor bio sensor of claim 1, wherein the dual gate ion-sensitive field effect transistor bio sensor comprises a dual gate ion-sensitive field effect transistor, and
the dual gate ion-sensitive field effect transistor comprises:
a lower gate electrode;
a lower insulating layer provided on the lower gate electrode;
a source and a drain provided on the lower insulating layer and separated from each other;
a channel layer provided on the lower insulating layer and disposed between the source and the drain;
an upper insulating layer provided on the source, the drain, and the channel layer; and
an upper gate electrode provided on the upper insulating layer.

3. The multiplexing detection system of the dual gate ion-sensitive field effect transistor bio sensor of claim 2, wherein the thickness of an equivalent oxide layer of the upper insulating layer is smaller than that of an equivalent oxide layer of the lower insulating layer.

4. The multiplexing detection system of the dual gate ion-sensitive field effect transistor bio sensor of claim 2, wherein the channel layer has a thickness of 10 nm or less.

5. The multiplexing detection system of the dual gate ion-sensitive field effect transistor bio sensor of claim 2, wherein the dual gate ion-sensitive field effect transistor bio sensor comprises a replaceable sensor connected with the dual gate ion-sensitive field effect transistor bio sensor, and
the replaceable sensor comprises a metal electrode connected with the upper gate electrode and
a sense layer provided on the metal electrode and sensing ion.

6. The multiplexing detection system of the dual gate ion-sensitive field effect transistor bio sensor of claim 2, wherein a source of the first dual gate ion-sensitive field effect transistor bio sensor and a source of the second dual gate ion-sensitive field effect transistor bio sensor are commonly grounded, and
an upper gate electrode of the first dual gate ion-sensitive field effect transistor bio sensor and an upper gate of the second dual gate ion-sensitive field effect transistor bio sensor are commonly grounded.

7. The multiplexing detection system of the dual gate ion-sensitive field effect transistor bio sensor of claim 6, wherein a common voltage is applied to a lower gate electrode of the first dual gate ion-sensitive field effect transistor bio sensor and a lower gate electrode of the second dual gate ion-sensitive field effect transistor bio sensor are commonly grounded.

8. The multiplexing detection system of the dual gate ion-sensitive field effect transistor bio sensor of claim 7, wherein a drain of the first dual gate ion-sensitive field effect transistor bio sensor outputs the first bio signal, and a drain of the second dual gate ion-sensitive field effect transistor bio sensor outputs the second bio signal.

9. The multiplexing detection system of the dual gate ion-sensitive field effect transistor bio sensor of claim 8, wherein the drain of the first dual gate ion-sensitive field effect transistor bio sensor and the drain of the second dual gate ion-sensitive field effect transistor bio sensor are connected in a parallel structure.

10. The multiplexing detection system of the dual gate ion-sensitive field effect transistor bio sensor of claim 5, wherein the replaceable sensor comprises a receptor where at least one of an antibody, a cell, and a DNA is functionalized, and
the replaceable sensor and the receptor are electrically connected.
